(19) United States
(12) Patent Application Publication
(10) Pub. No.: US 2018/0231908 A1
(43) Pub. Date: Aug. 16, 2018

(54) CHARGING ROLL FOR ELECTROPHOTOGRAPHIC APPARATUS

(71) Applicant: SUMITOMO RIKO COMPANY LIMITED, Komaki-shi (JP)

(72) Inventors: Kunio Ito, Komaki-shi (JP); Masanori Satoh, Komaki-shi (JP)

(73) Assignee: SUMITOMO RIKO COMPANY LIMITED, Komaki-shi (JP)

(21) Appl. No.: 15/955,828

(22) Filed: Apr. 18, 2018

Related U.S. Application Data
(63) Continuation of application No. PCT/JP2017/011759, filed on Mar. 23, 2017.

(30) Foreign Application Priority Data
Mar. 25, 2016 (JP) 2016-061429

(51) Int. Cl. G03G 15/02; B32B 1/08; B32B 15/18; B32B 15/20; B32B 15/082; B32B 15/06; B32B 15/088

(52) U.S. Cl. CPC G03G 15/0233; B32B 1/08; B32B 15/18; B32B 15/20; B32B 2559/00; B32B 15/06; B32B 15/088; B32B 2307/51; B32B 2307/202; B32B 15/082

(57) ABSTRACT

To provide a charging roll for an electrophotographic apparatus that is excellent in charging performance while suppressing adhesion of toner particles. A charging roll 10 includes a shaft body 12, an elastic body layer 14 provided on the outer periphery of the shaft body 12, and a surface layer 16 provided on the outer periphery of the elastic body layer 14. The surface layer 16 contains cellulose nanofibers, and has pores generated on the surface thereof due to overlapping of the cellulose nanofibers, and the pores have a diameter of 0.05 to 30 micrometers. The surface layer 16 preferably contains no binder resin or contains a binder resin at a content of 5 mass % or less with respect to the total content of the surface layer 16.

### TECHNICAL FIELD

The present disclosure relates to charging rolls for an electrophotographic apparatus that are suitably used in electrophotographic apparatuses such as copiers, printers, and facsimile apparatuses using a xerography method.

### BACKGROUND ART

To improve an antifouling property of a charging roll for an electrophotographic apparatus, particles are added onto the surface layer of the charging roll or the surface of the charging roll is scraped to produce fine asperities on the surface of the charging roll, whereby the contact surface between the charging roll and a photoconductor drum is reduced and toner particles, and or external additives are prevented from being rubbed into the surface of the charging roll (see Patent Document 1).

### CITATION LIST

### Patent Literature

Patent Document 1: JP 2008-116869 A

Patent Document 2: JP 2011-64783 A

### SUMMARY OF INVENTION

### Problems to be Solved by the Invention

In the configuration in which particles are added onto the surface layer of the charging roll, the possibility arises that the particles fall from the surface layer and the discharge space (i.e., the gap) between the surface of the charging roll and the surface of the photoconductor is reduced, which may lead to insufficient electrical discharge and deterioration in charging performance. Further, the possibility arises that the surface of the photoconductor is scraped due to the hardness of the particles on the charging roll and a space is generated between a cleaning blade and the photoconductor drum. Thus, sufficient cleaning cannot be performed due to slipping of toner particles or external additives between the blade and the drum, and further the slipped toner particles or external additives may be adhered to the charging roll. This causes deterioration in charging performance and streaks may appear in output images, resulting in image defects.

Patent Document 2 discloses that nanofibers are added to a binder resin in the surface layer of a developing roll. In Patent Document 2, the nanofibers are added as a reinforcement material and the amount of the binder resin is as large as 30% or more. Thus pores are not generated on the surface of the surface layer due to overlapping of the nanofibers.

An object of the present disclosure is to provide a charging roll for an electrophotographic apparatus that is excellent in charging performance while preventing adhesion of toner particles.

### Means for Solving the Problem

To achieve the objects and in accordance with the above-described purpose, a charging roll for an electrophotographic apparatus includes a shaft body, an elastic body layer provided on an outer periphery of the shaft body, and a surface layer provided on an outer periphery of the elastic body layer. The surface layer contains cellulose nanofibers, and has pores generated on the surface thereof due to overlapping of the cellulose nanofibers, wherein the pores have a diameter of 0.05 to 30 micrometers.

It is preferable that the surface layer contains no binder resin or contains a binder resin at a content of 5 mass % or less with respect to the total content of the surface layer. It is preferable that the surface layer has a surface area in the range of 300 to 60000 μm². It is preferable that the binder resin is a hydrophilic resin.

### Advantageous Effects of Invention

In the disclosed charging rolls for an electrophotographic apparatus, the discharge space (i.e., gap) is kept between the surface of the charging roll and the surface of the photoconductor because of the pores generated due to overlapping of the cellulose nanofibers, and thus an excellent charging performance is maintained. Further, local asperities of the charging roll is more suppressed when compared with the case in which spherical particles are added to the charging roll, and thus the stress on the photoconductor is reduced and the scraping of the surface of the photoconductor is also suppressed. Further, the pores generated due to overlapping of the cellulose nanofibers produce fine asperities on the surface of the charging roll, and thus the surface energy is decreased and adhesion of toner particles to the charging roll is suppressed. Hence, the adhesion of toner particles is prevented sufficiently.

### BRIEF DESCRIPTION OF DRAWINGS

FIG. 1A is a schematic view showing the exterior appearance of a charging roll for an electrophotographic apparatus according to the first embodiment of the present invention.

FIG. 1B is an A-A line cross-sectional view of the charging roll.

FIG. 2 is an enlarged schematic view of the surface of a surface layer of the charging roll illustrated in FIG. 1A and FIG. 1B.

### MODE FOR CARRYING OUT THE INVENTION

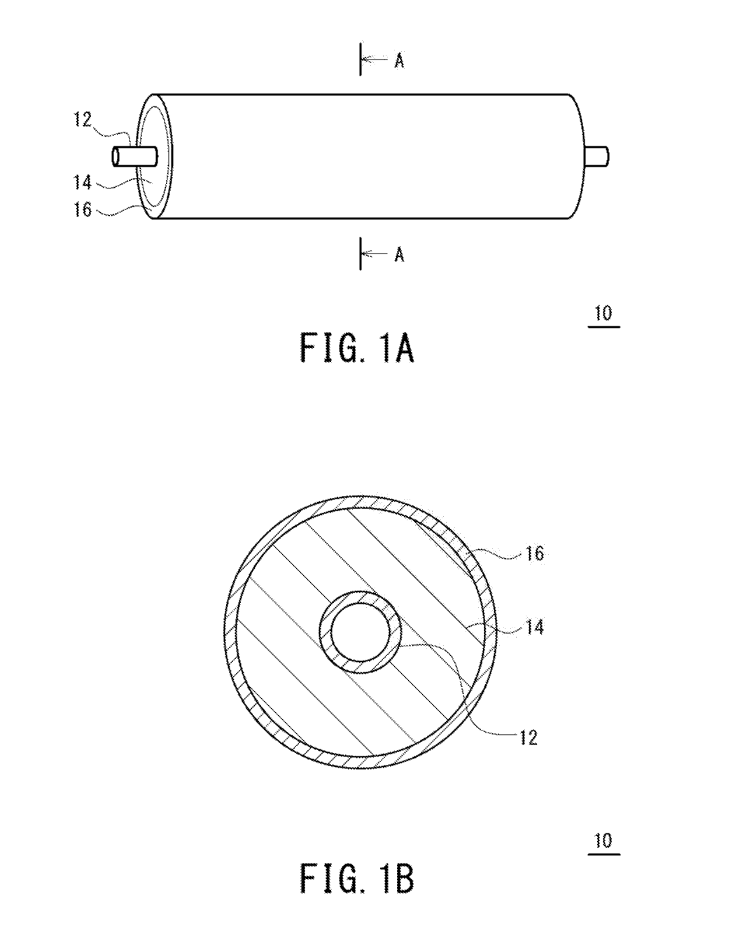

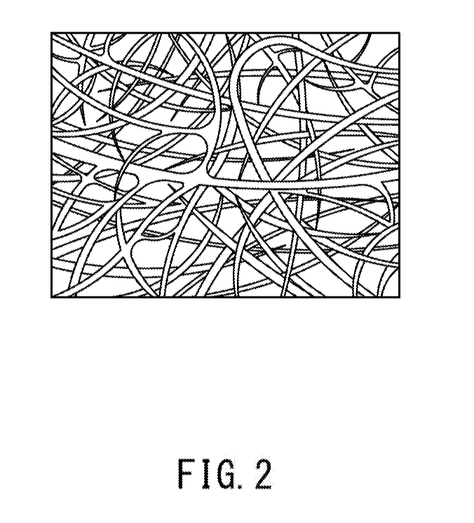

Detailed descriptions of a charging roll for an electrophotographic apparatus according to an embodiment of the present invention (hereinafter also referred to simply as the charging roll) will be provided. FIG. 1A is a schematic view showing the exterior appearance of a charging roll for an electrophotographic apparatus according to an embodiment of the present invention, and FIG. 1B is an A-A line cross-sectional view of the charging roll. FIG. 2 is an enlarged schematic view of the surface of a surface layer of the charging roll illustrated in FIG. 1A and FIG. 1B.

A charging roll 10 includes a shaft body 12, an elastic body layer 14 provided on the outer periphery of the shaft body 12, and a surface layer 16 provided on the outer periphery of the elastic body layer 14. The elastic body layer 14 defines a layer that constitutes a base of the charging roll 10. The surface layer 16 defines a layer that appears on the surface of the charging roll 10.

The surface layer 16 contains cellulose nanofibers and pores generated on the surface thereof due to overlapping of the cellulose nanofibers. The surface layer 16 containing the cellulose nanofibers is porous. The pores generated due to overlapping of the cellulose nanofibers contribute to produce and keep stable discharge gap between the surface of the charging roll 10 and the surface of the photoconductor. Further, falling of the cellulose nanofibers from the surface layer 16 is more suppressed than spherical particles in the case in which the spherical particles are added onto the surface layer, and thus the the cellulose nanofibers are kept on the surface layer 16 for a longer period, which lead to maintaining of excellent charging performance even during a long-term use. Further, in contrast to the case in which spherical particles are added onto the surface layer, local asperities of the charging roll 10 is suppressed, and thus the stress on the photoconductor is reduced and the scraping of the surface of the photoconductor is also suppressed. Further, the pores generated due to overlapping of the cellulose nanofibers produce fine asperities on the surface of the charging roll 10, and thus the surface energy is decreased and adhesion of toner particles is suppressed. Therefore, the adhesion of toner particles is prevented sufficiently. The cellulose nanofibers have a width of nanometer order: the width is in the range of 1 to 100 nanometers, while the length of the cellulose nanofibers is not particularly limited.

The pores on the surface of the surface layer 16 have a diameter of 0.05 micrometers or larger. Thus, the discharge gap is kept between the surface of the charging roll 10 and the surface of the photoconductor. From this viewpoint, it is preferable that the diameter of the pores is 0.1 micrometers or larger, more preferably 0.5 micrometers or larger, and still more preferably 1.0 micrometers or larger. Meanwhile, the pores on the surface of the surface layer 16 have a diameter of 30 micrometers or smaller. Thus, adequate pores and the resultant fine asperities are produced on the surface of the charging roll 10, whereby the surface energy is decreased and adhesion of toner particles is suppressed. From this viewpoint, it is preferable that the pores have a diameter of 25 micrometers or smaller, and more preferably 20 micrometers or smaller. When the pores on the surface of the surface layer 16 have a diameter in the range of 0.05 to 30 micrometers, the discharge gap and the fine asperities are kept adequately. The diameter of the pores on the surface of the surface layer 16 may be measured by SEM observation. The measurement is conducted in an area randomly selected on the surface of the surface layer 16. The area is magnified to 5000 to 20000 times and 20 pores are randomly selected in the area of 15×25 micrometers. The largest diameter of each pore is measured, and the average diameter of the 20 pores is defined as the diameter of the pores in the area. The measurement is similarly conducted for randomly selected five areas and the average diameter of the randomly selected five areas is defined as the diameter of the pores on the surface of the surface layer 16.

It is preferable that the surface area of the surface layer 16 is in the rage of 300 to 60000 μm² and more preferably in the range of 1000 to 20000 μm² from the viewpoint of keeping stable discharge gap. The surface area of the surface layer 16 can be measured using a laser microscope. The surface area of the surface layer 16 is defined as the value per unit volume (μm³)

It is preferable that the surface layer 16 contains no binder resin or contains a relatively small amount of binder resin. When the surface layer 16 contains no binder resin or contains a relatively small amount of binder resin, the pores are generated on the surface of the surface layer 16 and the surface layer 16 may be formed as a porous layer due to the overlapping of the cellulose nanofibers. Meanwhile, when the surface layer 16 contains binder resins in a large amount, the pores generated due to the overlapping of the cellulose nanofibers are filled with the binder resins, and thus the surface layer 16 is formed as a layer with no pores on its surface. When the cellulose nanofibers are used as a reinforcement material, for example, the amount of the binder resin that constitutes the main component of the surface layer 16 is necessarily large, essentially. Accordingly, when the cellulose nanofibers are used as a reinforcement material, the surface layer 16 is formed as a layer with no pores on the surface thereof due to the large amount of the binder resin. In the present embodiment, the binder resin is used to ensure mutual binding of the cellulose nanofibers or to promote fixing of the cellulose nanofibers to the surface of the elastic body layer 14. For this reason, the amount of the binder resin is set not to allow filling of the pores generated due to the overlapping of the cellulose nanofibers with the binder resin. From this viewpoint, it is preferable that the amount of the binder resins is 5 mass % or less, more preferably 4 mass % or less, and still more preferably 3 mass % or less with respect to the total content of the surface layer 16.

The type of the binder resins is not particularly limited; however, a preferred material can be selected depending on the required characteristic. Examples of the binder resins include an acrylic resin, a methacrylic resin, a fluorine-containing resin, a silicone resin, a polycarbonate resin, a urethane resin, and a polyamide resin. Among them, a single type of resin may be used alone as a binder polymer of the surface layer 16, or two or more kinds of resins may be used in combination. It is preferable that the binder resin is a hydrophilic resin from the viewpoint of the use in combination with the cellulose nanofibers and easiness in preparation of an aqueous dispersion. From this viewpoint, the polyamide resin is most preferable as the binder resin.

The surface layer 16 may contain or not contain additives in addition to the cellulose nanofibers or in addition to the cellulose nanofibers and the binder resin. Examples of the additives include a conductive agent, a stabilizer, a UV absorber, a lubricant, a mold-releasing agent, a dye, a pigment, and a flame retardant. Examples of the conductive agent include an ion conductive agent (e.g., a quaternary ammonium salt) and an electric conductive agent (e.g., a carbon black).

The surface layer 16 can be adjusted to have a predetermined volume resistivity depending on the type of the materials and the combination of the conductive agents. The volume resistivity of the surface layer 16 may be set as appropriate in the range of 10⁵ to 10¹¹ Ω·cm or in the range of 10⁸ to 10¹⁰ Ω·cm depending on the intended use. The thickness of the surface layer 16 is not particularly limited, and may be set as appropriate in the range of 10 to 30 micrometers depending on the intended use.

The thickness of the surface layer 16 is not particularly limited; however, it is preferably one micrometer or larger, and more preferably two micrometers or larger from the viewpoint of leak resistance. Meanwhile, the thickness of the surface layer 16 is preferably 6 micrometers or smaller, and more preferably 5 micrometers or smaller from the viewpoint of setting.

The surface layer 16 may be formed by applying a surface layer forming composition containing cellulose nanofibers to the outer periphery of the elastic body layer 14 and drying the elastic body layer 14 as appropriate. The cellulose nanofibers contained in the surface-layer forming composition may be prepared as an aqueous dispersion liquid using a dispersion medium such as water.

The elastic body layer 14 contains crosslinked rubber. The elastic body layer 14 is made from a conductive rubber composition containing uncrosslinked rubber. The crosslinked rubber can be obtained by crosslinking uncrosslinked rubber. The uncrosslinked rubber may be polar rubber, or non-polar rubber. The uncrosslinked rubber is preferably polar rubber from the viewpoint of having excellent conductivity.

Polar rubber is rubber having a polar group, and examples of the polar group include a chloro group, a nitrile group, a carboxyl group, and an epoxy group. Specific examples of the polar rubber include hydrin rubber, nitrile rubber (NBR), urethane rubber (U), acrylic rubber (a copolymer of acrylic acid ester and 2-chloroethyl vinyl ether; ACM), chloroprene rubber (CR), and epoxidized natural rubber (ENR). Among the polar rubbers, hydrin rubber and nitrile rubber (NBR) are preferred from the viewpoint of easily achieving a very low volume resistivity.

Examples of the hydrin rubber include an epichlorohydrin homopolymer (CO), an epichlorohydrin-ethylene oxide binary copolymer (ECO), an epichlorohydrin-allyl glycidyl ether binary copolymer (GCO), and an epichlorohydrin-ethylene oxide-allyl glycidyl ether ternary copolymer (GECO).

Examples of the urethane rubber include polyether type urethan rubber having an ether bond in the molecule. The polyether type urethane rubber can be produced by reaction of a polyether having a terminal hydroxyl group and a diisocyanate. The polyether is not particularly limited; however, examples of the polyether include a polyethylene glycol and a polypropylene glycol. The diisocyanate is not particularly limited; however, examples of the diisocyanate include a tolylene diisocyanate and a diphenylmethane diisocyanate.

Examples of the non-polar rubber include isoprene rubber (IR), natural rubber (NR), styrene-butadiene rubber (SBR), and butadiene rubber (BR).

Examples of the crosslinking agent include a sulfur crosslinking agent, a peroxide crosslinking agent, and a dechlorination crosslinking agent. Among them, a single kind of crosslinking agent may be used alone, or two or more kinds of crosslinking agents may be used in combination.

Examples of the sulfur crosslinking agent includes conventionally known sulfur cross-linking agents such as powdered sulfur, precipitated sulfur, colloidal sulfur, surface treated sulfur, insoluble sulfur, sulfur chloride, a thiuram vulcanization accelerator, and a polymer polysulfide.

Examples of the peroxide crosslinking agent include conventionally known crosslinking agents such as a peroxy ketal, a dialkyl peroxide, a peroxy ester, a ketone peroxide, a peroxydicarbonate, a diacyl peroxide, and a hydroperoxide.

Examples of the dechlorination crosslinking agent include dithiocarbonate compounds. Specific examples thereof include quinoxaline-2,3-dithiocarbonate, 6-methylquinoxaline-2,3-dithiocarbonate, 6-isopropylquinoxaline-2,3-dithiocarbonate, and 5,8-dimethylquinoxaline-2,3 dithiocarbonate.

The amount of the crosslinking agent is preferably in the range of 0.1 to 2 parts by mass with respect to 100 parts by mass of the uncrosslinked rubber, more preferably in the range of 0.3 to 1.8 parts by mass, and still, more preferably in the range of 0.5 to 1.5 parts by mass from the viewpoint of not easily bleeding.

When using a dechlorination crosslinking agent as the crosslinking agent, a dechlorination crosslinking accelerator may be used in combination. Examples of the dechlorination crosslinking accelerator include 1,8-diazabicyclo (5,4,0) undecene-7 (hereinafter abbreviated as DBU) and a weak acid salt thereof. The dechlorination crosslinking accelerator may be used in the form of DBU; however, it is preferably used in the form of a weak acid salt from the viewpoint of ease in handling. Examples of the weak acid salt of DBU include a carbonate, a stearate, a 2-ethylhexylate, a benzoate, a salicylate, a 3-hydroxy-2-naphthoate, a phenol resin salt, a 2-mercaptobenzothiazole salt, and a 2-mercaptobenzimidazole salt.

The content of the dechlorination crosslinking accelerator is preferably in the range of 0.1 to 2 parts by mass with respect to 100 parts by mass of the uncrosslinked rubber, more preferably in the range of 0.3 to 1.8 parts by mass, and still, more preferably in the range of 0.5 to 1.5 parts by mass from the viewpoint of not easily bleeding.

It is possible to add conventionally known conductive agents such as a carbon black, graphite, c-TiO₂, c-ZnO, c-SnO₂ (c- means conductivity.), ion conductive agents (e.g., a quaternary ammonium salt, a borate salt, and a surface acting agent) to the elastic body layer 14 as appropriate in order to impart conductivity. In addition, a variety of additives may be added to the elastic body layer 14 as appropriate if needed. Examples of the additives include a lubricant, a vulcanization accelerator, an anti-aging agent, a light stabilizer, a viscosity modifier, a processing aid, a flame retardant, a plasticizer, a foaming agent, a filler, a dispersing agent, an antifoaming agent, a pigment, and a mold-releasing agent.

The elastic body layer 14 can be adjusted to have a predetermined volume resistivity depending on the type of an uncrosslinked rubber, the amount of an ion conductive agent, or the composition of an electroconductive agent. The volume resistivity of the elastic body layer 14 may be set as appropriate in the range of 10² to 10¹⁰ Ω·cm, in the range of 10³ to 10⁹ Ω·cm, or in the range of 10⁴ to 10⁸ Ω·cm.

The thickness of the elastic body layer 14 is not particularly limited, and may be set as appropriate in the range of 0.1 to 10 mm depending on the intended use.

The elastic body layer 14 can be produced as follows, for example. First, the elastic body layer 14 is formed on the outer periphery of the shaft body 12 by coaxially installing the shaft body 12 in a hollow portion of a roll molding die and injecting an uncrosslinked conductive rubber composition thereinto to heat/cure (crosslink) the composition, and then releasing it from the die, or by extrusion-molding an uncrosslinked conductive rubber composition on the surface of the shaft body 12.

The shaft body 12 is not particularly limited as long as it has conductivity. To be specific, examples of the shaft body 12 include a solid member consisting of a solid body or a hollow body made from metal such as iron, stainless steel, and aluminum. An adhesive or a primer may be applied to the surface of the shaft body 12 as necessary. That is, the elastic body layer 14 may be bonded to the shaft body 12 via an adhesive layer (a primer layer). The adhesive and the primer may be made conductive as necessary.

The charging roll 10 having the above-described configuration secures the discharge space (gap) between the surface of the charging roll and the surface of the photoconductor because of the pores generated due to the overlapping of the cellulose nanofibers in the surface layer 16, and thus an excellent charging performance is maintained. Further, local asperities of the charging roll 10 is more suppressed when compared with the case in which spherical particles are added to the charging roll 10, and thus the stress on the photoconductor is reduced and the scraping of the surface of the photoconductor is also suppressed. Further, the pores generated due to the overlapping of the cellulose nanofibers produce fine asperities on the surface of the charging roll 10, and thus the surface energy is decreased and adhesion of toner particles is suppressed. Hence, the adhesion of toner particles is suppressed sufficiently.

The configuration of the charging roll according to the embodiment of the present invention is not limited to the configuration illustrated in FIG. 1A and FIG. 1B. For example, the charging roll 10 illustrated in FIG. 1A and FIG. 1B may have a configuration of including another elastic body layer between the shaft body 12 and the elastic body layer 14. In this case, the another elastic body layer defines a base layer of the charging roll, and the elastic body layer 14 functions as a resistance adjusting layer arranged to adjust the resistance of the charging roll. The another elastic body layer can be made from, for example, any of the above-described materials from which the elastic body layer 14 is made. In addition, the charging roll 10 illustrated in FIG. 1A and FIG. 1B may have a configuration of including another elastic body layer between the elastic body layer 14 and the surface layer 16. In this case, the elastic body layer 14 defines a base layer of the charging roll, and the another elastic body layer functions as a resistance adjusting layer arranged to adjust the resistance of the charging roll.

### EXAMPLE

Hereinafter, the embodiment of the present invention will be described in detail with reference to examples and comparative examples.

### Examples 1 to 3, and Comparative Examples 1 and 2

### Preparation of Conductive Rubber Composition

In each example, a conductive rubber composition was prepared by adding to 100 parts by mass of hydrin rubber (ECO, “EPICHLOMER CG102” manufactured by DAISO CO., LTD.) 5 parts by mass of a vulcanization aid (zinc oxide, “Type-2 zinc oxide” manufactured by MITSUI MINING & SMELTING CO., LTD), 10 parts by mass of carbon (“Ketjen Black EC 300J” manufactured by KETJEN BLACK INTERNATIONAL COMPANY), 0.5 parts by mass of a vulcanization accelerator (2-mercaptobenzothiazole, “NOCCELER-M-P” manufactured by OUCHI SHINKO CHEMICAL INDUSTRIAL CO., LTD.), 2 parts by mass of sulfur (“SULFAX PTC” manufactured by TSURUMI CHEMICAL INDUSTRY CO., LTD.) and 50 parts by mass of a filler (calcium carbonate, “HAKUENKA CC” manufactured by SHIRAISHI KOGYO KAISHA, LTD.) and they were agitated and mixed with the use of an agitator.

### Preparation of Elastic Body Layer

In each example, a core metal (a shaft body having a diameter of 6 mm) was installed in a molding die, the above described conductive rubber composition was injected to the molding die, was heated for 30 minutes at 170 degrees C., and then was cooled. The product was released from the die, and thus an elastic body layer having a thickness of 1.5 mm was formed around the outer periphery of the core metal.

### Preparation of Surface Layer

In each example, an aqueous dispersion of cellulose nanofibers (CNF) was prepared to have a solid component concentration (in mass %) shown in Table 1. The surface of the elastic body layer was coated with the dispersion and heated for 30 minutes at 100 degrees C., and thus a surface layer having a thickness of 2.5 micrometers was formed on the outer surface of the elastic body layer. A charging roll was produced in this manner.
CNF 1 (cellulose nanofibers 1): “LIGNO CNF 45” manufactured by MORI MACHINERY CORPORATION.
CNF 2 (cellulose nanofibers 2):“LIGNO CNF 250” manufactured by MORI MACHINERY CORPORATION.

### Examples 4 and 5, and Comparative Example 3

In each example, the surface layer was formed on the outer periphery of the elastic body layer in a manner similar to examples 1 to 3 except that a binder resin was added to the aqueous dispersion of the cellulose nanofibers (CNS). A charging roll was produced in this manner.
Binder resin 1: acrylic resin; “VONCOAT SEP-119” manufactured by DIC corporation.
Binder resin 2: nylon resin; “Fine Resin FR-104” manufactured by NAMARIICHI CO., LTD.

The diameter of the pores on the surface layer and the surface area of the surface layer were measured for each produced charging roll. Further, streaks in images and toner fogging were evaluated. The results of the evaluation and the contents of the compositions forming the surface layer were shown in the table below.

(Diameter of Pores)

In each example, the measurement of the diameter of the pores was conducted in an area randomly selected on the surface of the surface layer. The area was magnified to 5000 to 20000 times, and 20 pores were randomly selected in the area of 15×25 micrometers. The largest diameter of each pore was measured, and the average diameter of the 20 pores was defined as the diameter of the pores in the area. The measurement was similarly conducted for randomly selected five areas and the average diameter of the randomly selected five areas was defined as the diameter of the pores on the surface in the surface layer.

(Surface Area)

In each example, the surface of the surface layer was observed using a laser microscope and the surface area was defined as the value per unit volume (μm³).

Measuring equipment:
A device equivalent to a “Color 3D laser microscope VK-X100” manufactured by KEYENCE CORPORATION.
Measurement conditions:
magnification: ×3000, brightness: 7850, and measurement pitch: 0.05 micrometers.
Analysis condition:
upper limit threshold: 40000 in volume/area modes.

(Streaks in Images)

Each of the produced charging rolls was installed in a cartridge (black cartridge) of an actual device (“CLJ4525dn” manufactured by Hewlett-Packard Company), and then a sheet of half-tone image was outputted in 25% concentration under an environment of 15 degrees C. and 10 RH %. The charging rolls with which favorable images were formed without horizontal streaks were regarded as “very good”, the charging rolls with which images were formed with few horizontal streaks were regarded as “good”, and the charging rolls with which images were formed with horizontal streaks with a large adverse effect of toner adhesion were regarded as “poor”.

(Toner Fogging)

Each of the produced charging rolls was installed in the cartridge (black cartridge) of the actual device (“CLJ4525dn” manufactured by Hewlett-Packard Company), and then a white solid printing was performed under an environment of 15 degrees C. and 10 RH % The charging rolls with which images were formed with the change in image reflectance of 1% or less were regarded as “very good”, the charging rolls with which images were formed with the change in image reflectance over 1% and 3% or less were regarded as “good”, the charging rolls with which images were formed with the change in image reflectance over 3% and 4% or less were regarded as “slightly poor”, and the charging rolls with which images were formed with the change in image reflectance over 4% were regarded as “poor”. The image reflectance was measured using a white photometer (“Digital white photometer TC-6DS/A”, manufactured by Tokyo Denshoku CO., LTD.)

TABLE 1

| | Example | | | | | Comparative Example | | |
|---|---|---|---|---|---|---|---|---|
| | 1 | 2 | 3 | 4 | 5 | 1 | 2 | 3 |
| CNF1 (solid component %) | 1.0 | — | — | — | — | 3.0 | — | — |
| CNF2 (solid component %) | — | 0.1 | 0.5 | 0.5 | 0.5 | — | 0.001 | 0.5 |
| Binder 1 (solid component %) | — | — | — | 3 | — | — | — | — |
| Binder 2 (solid component %) | — | — | — | — | 3 | — | — | 10 |
| Diameter of pores (μm) | 0.06 | 30 | 1.6 | 1.5 | 1.3 | 0.01 | 50 | 0 |
| Surface area (μm²) | 350 | 58550 | 22500 | 3800 | 3200 | 25 | 68000 | 1.5 |
| Streaks in images | Very good | Good | Very good | Very good | Good | Poor | Very good | Poor |
| Toner fogging | Very good | Good | Good | Very good | Very | Very | Poor | Very |
| | | | | | good | good | | good |

CNF: LIGNO CNF 45
CNF2: LIGNP CNF 250
Binder 1: acrylic resin
Binder 2: nylon resin

In comparative example 1, the solid component concentration of the cellulose nanofibers was high, and thus the diameter of the pores generated due to overlapping of the cellulose nanofibers in the surface layer was too small. In comparative example 2, the solid component concentration of the cellulose nanofibers was low, and thus the diameter of the pores generated due to overlapping of the cellulose nanofibers in the surface layer was too large. Meanwhile, in each example, the diameter of the pores generated due to overlapping of the cellulose nanofibers was adequate. Thus, the discharge space (gap) was kept between the surface of the charging roll and the surface of the photoconductor, an excellent charging performance was maintained, and toner fogging was suppressed. Further, fine asperities were formed on the surface of the charging roll, and thus the surface energy was decreased, and adhesion of toner particles to the charging roll and formation of images with streaks were suppressed. In comparative example 3, the solid component concentration of the binder resin was high, and thus pores were not generated due to overlapping of the cellulose nanofibers in the surface layer. Thus, formation of images with streaks was not prevented.

Having thus described in detail one of the embodiments of the present invention, the embodiments of the present invention are not intended to be limited to the above embodiments, various modifications are possible without departing from the scope of the disclosure.

1. A charging roll for an electrophotographic apparatus comprising:
a shaft body;
an elastic body layer provided on an outer periphery of the shaft body; and
a surface layer provided on an outer periphery of the elastic body layer, the surface layer comprising cellulose nanofibers,
wherein the surface layer has pores having a diameter of 0.05 to 30 micrometers, the pores generated due to overlapping of the cellulose nanofibers, and
the surface layer does not comprise a binder resin or comprises a hydrophilic binder resin at a content of 5 mass % or less with respect to the total content of the surface layer, and has a surface area in the range of 300 to 60000 μm².
